(19) United States
(12) Patent Application Publication
(10) Pub. No.: US 2004/0104865 A1
(43) Pub. Date: Jun. 3, 2004

(54) Method and device for coding/decoding information for defining a window in a video image

(76) Inventors: Christine Masson, Varces Allieres Et Risset (FR); Gerard Bret, Echirolles (FR); Frederic Tupin, Saint Martin d'Here (FR); Olivier Le Briz, Saint-Gervais (FR)

Correspondence Address: DOCKET CLERK, P.O. DRAWER 800889, DALLAS, TX, 75380, US

(21) Appl. No.: 10/409,641

(22) Filed: Apr. 8, 2003

(30) Foreign Application Priority Data
Apr. 8, 2002 (FR) 0204329

(51) Int. Cl. G09G 1/08

(52) U.S. Cl. 345/13

(57) ABSTRACT

For the coding of information for defining a determined window in a video image, a coding pulse is transmitted in a first of the R,G,B video signals sent to a cathode ray tube monitor. The coding pulse is transmitted within at least one time window associated with a determined frame line, and has a temporal width which corresponds to the width of the window in the video image.

### BACKGROUND OF THE INVENTION

1. Field of the Invention

The present invention generally relates the displaying of stationary or moving images on the screen of a cathode ray tube monitor or CRT monitor, which is linked to a computer central unit or the like by way of a video cable.

More particularly, it proposes methods and devices for coding and decoding information for defining a determined window in a video image, this information being transmitted in some at least of the R,G,B video signals sent to the CRT monitor. Defining a window is understood to mean the marking of the coordinates making it possible to locate the window in the displayed image.

Applications of the inventor are in particular in video coders such as those used for the emulation of video cards for computers or the like, and in video decoders such as those used in CRT monitors.

2. Description of the Related Art

Represented in FIG. 1 is the central unit 20 of a computer, which is linked to a CRT monitor 10 by way of a video cable 30. The video cable 30 serves to send information for displaying video images on the screen 11 of the monitor, under the control of an application program which is executed by a microprocessor (not represented) of the central unit 20. The central unit 20 comprises a video card adapted to the type of the monitor, so as to shape the information sent, of a format allowing it to be decoded in the monitor. The monitor 20 is for example a VGA type monitor, the video card then being a VGA card.

As is illustrated diagrammatically in FIG. 2, the video cable 30 comprises various wires. Firstly, it comprises three wires defining three channels over which video signals commonly referred to as R, G and B signals are sent. By extension these channels are also referred to as R,G,B channels in the jargon of the person skilled in the art. The R,G,B signals are analogue signals whose amplitude determines the level of the primary colours, respectively red, green and blue, which make up the colour of a pixel on the screen 11 of the monitor 10. The video cable 30 also comprises two other wires which transport vertical and horizontal synchronization signals for the cathode ray tube scanning device, commonly referred to as Vsync and Hsync signals in the jargon of the person skilled in the art. It also comprises several wires which constitute a digital data bus, commonly referred to as a DDC bus (standing for “Digital Data Control”). The video cable 30 comprises yet other wires (not represented) for sending other signals, in particular other synchronization signals and/or other data signals.

The Vsync and Hsync synchronization signals define video frames, each of which containing the information required for displaying a stationary image on the screen 11 in full. A video frame corresponds to the information sent on the R,G,B channels between two pulses of the Vsync signal. More exactly, a pulse of the Vsync signal indicates the start of the sending in the R,G,B signals of the information associated with the first line of the frame, and a pulse of the Hsync signal indicates the start of the sending in the R,G,B signals of the information associated with a determined line of the frame. For a VGA screen having 800 lines and 600 columns at most, there are therefore 800 pulses of the Hsync signal for one pulse of the Vsync signal.

The frames are sent successively. By way of convention, the lines of a frame are sent successively, beginning with the top line of the screen 11 and ending with the bottom line of the screen. In what follows, the words “first”, “last”, “next”, and “consecutive” used in reference to frames or to lines of the frame are used in reference to this convention.

In fact, not all the lines of the frame are displayed on the screen of the monitor, since it is necessary to devise time intervals for the flyback of the vertical deflectors of the cathode ray tube ensuring vertical deflection of the electron beam. Likewise, in each line, not all columns are displayed, since it is necessary to devise time intervals for the flyback of the horizontal deflectors of the monitor which ensure the horizontal deflection of the electron beam. In what follows, the lines of the frame at least some of whose points are displayed on the screen of the monitor are referred to as video lines, and those which are not displayed are referred to as non-video lines. Also, the set formed by the displayed points is referred to as a video image.

As is illustrated diagrammatically in FIG. 3, the whole area 12 of the screen 11 is not therefore used for display. Only a limited part of this area serves in the display of the video image 13. In FIG. 3, a period of the Hsync signal has been diagrammatically represented horizontally above the outline symbolizing the area 12 of the screen 11, and a period of the Vsync signal has been diagrammatically represented vertically on the right of this outline.

The R,G,B video signals may contain, in the time intervals of the frame which are associated with the non-video lines of the frame, digital data instead of analogue data defining primary colour levels. Such data correspond for example to adjustment information, or user data.

The application program executed by the computer uses, to define the coordinates of the elements of the image to be displayed, a reference system tied to the video image 13. Now, the monitor only operates in a reference system tied to the frame, that is tied to the area 12 of the screen 11 since it is synchronized by the Vsync and Hsync synchronization signals of the frame.

Represented diagrammatically in FIG. 4 are the means of a CRT monitor of the prior art.

The monitor 10 comprises inputs Gin, Bin, Rin, Hin and Vin connected to the video cable 30 for respectively receiving the G, B, and R video signals, and the Hsync and Vsync synchronization signals. It further comprises a preamplifier 15, a circuit 16 for management of the OSD (“On-Screen Display”) also referred to as an OSD circuit in what follows, a high-voltage amplifier 17, and a cathode ray tube 18.

The G, B, and R signals received on the inputs Gin, Bin and Rin of the monitor are sent to inputs Gin, Bin and Rin respectively, of the preamplifier 15 by way of capacitors C1, C2 and C3, respectively.

The preamplifier 15 comprises three outputs Gout, Bout and Rout for delivering the preamplified G, B and R video signals, respectively. It more particularly comprises a first video channel linking its input Gin to its output Gout and comprising an amplifier A1. The input of amplifier A1 is linked to the input Gin, and its output is linked to a first input of a switch I1 having two inputs. The output of the switch I1 is linked to the input of a second amplifier A4 whose output is linked to the output Gout. The second input of the switch I1 is linked to an input Gc of the preamplifier 15.

The preamplifier 15 further comprises a second video channel linking its input Bin into its output Bout which comprises an amplifier A2. The input of amplifier A2 is linked to the input Bin, and its output is linked to a first input of a switch I2 having two inputs. The output of the switch I1 is linked to the input of a second amplifier A5 whose output is linked to the output Bout. The second input of the switch I2 is linked to an input Bc of the preamplifier 15.

The preamplifier 15 finally comprises a third video channel linking its input Rin into its output Rout which comprises an amplifier A3. The input of amplifier A3 is linked to the input Rin, and its output is linked to a first input of a switch I3 having two inputs. The output of the switch I3 is linked to the input of a second amplifier A6 whose output is linked to the output Rout. The second input of the switch I3 is linked to an input Rc of the preamplifier 15.

The positioning of the switches I1, I2 and I3 is controlled by a signal Fblk received on an input Fc of the preamplifier 15. In a first position of these switches, the G, B and R signals received respectively on the inputs Gin, Bin and Rin of the preamplifier 15 and amplified by the amplifiers A1, A2 and A3 respectively, are received by the respective inputs of the amplifiers A4, A5 and A6. In the second position of the switches I1, I2 and I3, the inputs of the amplifiers A4, A5 and A6 receive G, B and R video signals received respectively on the inputs Gc, Bc and Rc of the preamplifier 15. The signal Fblk is therefore a binary signal which simultaneously controls the three switches I1, I2 and I3. The preamplifier 15 is for example a circuit marketed by the company STMicroelectronics under the reference STV9211.

The circuit 16, receives the Hsync and Vsync synchronization signals on inputs Hin and Vin respectively, and delivers G, B and R video signals on outputs Gout, Bout and Rout respectively. Further, it generates the signal Fblk and delivers it on an output Fout. The circuit 16 is for example the circuit marketed by the company STMicroelectronics under the reference STV9936. Its function is to manage the displaying, on the screen of the CRT monitor, of an OSD window allowing adjustment of the display parameters of the monitor, the position and the dimensions of this OSD window being fixed, that is determined in advance and recorded in a ROM memory of the circuit 16. The operation of the OSD circuit takes place when a function for adjusting the display parameters of the monitor is activated by the user. In short, this operation makes it possible to substitute the G,B,R video signals received on the inputs Gin, Bin and Rin respectively of the CRT monitor with the G,B,R video signals produced by the OSD circuit, for displaying the pixels of the OSD window.

The G, B and R video signals delivered on the outputs Gout, Bout and Rout respectively of the preamplifier 15 are sent to the suitable inputs of the cathode ray tube 18 through the high-voltage amplifier 17.

In certain applications, it is desirable to modify the display parameters of the monitor for certain zones of the screen, in which zone or zones stationary or moving images are displayed. These display parameters are the contrast, the brightness and the dynamic contrast (otherwise known as sharpness). In particular, for the displaying of photographs or of film sequences, it is preferable to increase the values of the contrast, of the brightness and/or of the preaccentuation in order to ensure better photographic rendition than with the values of these parameters commonly used for the displaying of text data or icons. Also, the values of these parameters should only be increased in these zones, so as not to make it difficult or tiring for the eyes to read the text data or icons which may be displayed in the remainder of the video image.

Such a zone is represented in FIG. 1 and in FIG. 3 in the form of a window 14. In this example, the relevant zone is in fact a rectangle, although this is not limiting on the invention. The window may be defined by the user with the aid of a mouse 21 associated with a mouse pointer 22 displayed on the screen 11 of the monitor 10. The window 14 is defined in the reference system tied to the video image 13, by coordinate values X1, X2, Y1 and Y2 defined for example in the following manner:

X1 is the distance between the left border of the window 14 and the left border of the video image 13;

X2 is the distance between the right border of the window 14 and the left border of the video image 13;

Y1 is the distance between the upper border of the window 14 and the upper border of the video image 13; and

Y2 is the distance between the lower border of the window 14 and the upper border of the video image 13.

The values X1 and X2 are expressed in time units defined by an internal clock circuit of the monitor which regulates the displaying of the points of a line of the frame. For the sake of simplicity, these points will be referred to as “pixels”, although the concept of pixel is independent of the resolution of the monitor and although, on the contrary, the frequency of the internal clock signal of the monitor is modified when the resolution of the monitor is modified (whenever such a modification of the resolution of the monitor is possible). The values Y1 and Y2 are expressed on the other hand as a number of frame lines.

The monitor 10 needs to know the coordinates of the window 14, in order to increase the value of the display parameters when necessary, that is when displaying the pixels of this window only.

There is therefore a need for a method making it possible to send information defining the coordinates (that is the position and the dimensions) of a window in a video image. Given that the application program produces coordinates in the reference system tied to the video image, it is further necessary to convert them so as to express them in the reference system of the frame.

The European Patent Application No. 957,631 discloses an embodiment in which a control signal is sent on a specific line between the central unit of a computer and a CRT monitor, this signal comprising synchronized pulses whose number and duration determine the dimensions (vertical dimension or height, and horizontal dimension or width) of the window. Nevertheless, this embodiment involves the use of a specific line for sending the data defining the coordinates of the window.

It is also conceivable to use a data bus linking the central unit 20 to the monitor 10, for example a USB link (standing for “Universal Serial Bus”). Nevertheless, this incurs additional cost in respect of the USB interface of the monitor.

It is also conceivable to use the DCC bus contained in the video cable 30. However, this may raise problems of compatibility with certain video cards on the market.

A known solution consists in using the video signals sent on the video cable 30. The International Patent Application No. 01/41,117 thus discloses a device and a method for generating display data allowing the defining by a CRT monitor of a window in a video image displayed on the screen of a monitor, with a view to applying display parameters which are different for the pixels of the said window and for those of the remainder of the video image. The R,G,B signals are used to send time reference information on the one hand, and coordinates of a window which are expressed in the reference system of the video image on the other hand.

The time reference information comprises a first instant of occurrence and a first order number which are associated with a first determined pixel of the active image, as well as a second instant of occurrence and a second order number which are associated with a second determined pixel of the active image. The first and the second pixels belong to one and the same line of the frame. They are preferably the first and the last pixel displayed of a video line. In this case, only information relating to the total number of pixels of a line of the active image is sent instead of the said first and second order numbers. This is carried out by transmitting on one of the R,G,B video signals, within a time window associated with a determined line of the frame, a pulse whose start edge indicates the left border of the video image and whose temporal width corresponds to the width of the video image. The said line of the active image is the last line of the active image and is masked before being displayed, or is excluded from the active image by reducing the size of the latter by one line. In this way, the reference information does not appear visibly on the screen.

Moreover, first and second horizontal coordinates X1 and X2 are sent to the monitor in one of the R,G,B signals or in a specific signal carried by a data bus said coordinates defining, in a reference system associated with the video image, the start and the end respectively, of the window (along the horizontal axis).

A window management circuit, which is contained in the monitor, then calculates the horizontal coordinates of the window in the reference system tied to the frame, on the basis of the said time reference information on the one hand, and of the said horizontal coordinates X1 and X2 on the other hand. The window management circuit generates a control signal for the preamplifier of the monitor, which is at a determined level when the display parameters of the window are to be applied.

Similar arrangements allow the window management circuit to calculate the vertical coordinates of the window in the reference system tied to the frame. The first and the second determined pixels are then pixels belonging to different lines of the video frame.

A drawback of the method and of the device thus described, is that the calculations performed by the window management circuit of the monitor are complex. Specifically, these calculations comprise a multiplication and a division for each of the four coordinates of the window. Moreover, they require the addition of a component specifically dedicated to this function.

### SUMMARY OF THE INVENTION

A first aspect of the invention relates to a method for coding information for displaying a determined window in a video image to be displayed in a monitor having a cathode ray tube. The method comprises the step of transmitting a coding pulse in synchronism with a horizontal synchronisation signal of said cathode ray tube, in a first one of the R,G,B video signals sent to said monitor. The coding pulse is transmitted in at least one frame determined within at least one time window associated with a determined frame line. The coding pulse has a temporal width which corresponds to the width of the window in the video image.

A second aspect of the invention relates to a device for coding information for displaying a determined window in a video image to be displayed in a monitor having a cathode ray tube. The device comprises means for transmitting, in a first one of R,G,B video signals sent to the monitor, and, in at least one frame determined within at least one time window associated with a determined frame line, a coding pulse synchronized with a horizontal synchronization signal of the cathode ray tube. The coding pulse has a temporal width which corresponds to the width of the said window in the said video image.

A third aspect of the invention relates to a method for decoding information for defining a determined window in a video image to be displayed in a monitor having a cathode ray tube, said information being coded in some at least of the R,G,B video signals sent to the monitor. The method comprises the step of receiving a coding pulse which is synchronized with a horizontal scanning signal of the cathode ray tube in a first one of the R,G,B video signals, said coding pulse being received in at least one determined frame within at least one time window associated with a determined frame line. The method further comprise a step of counting time units onwards of the start of the frame line, a step of storing a first horizontal count value on receipt of a start edge of the coding pulse, and a step of storing a second horizontal count value on receipt of an end edge of the coding pulse. The first horizontal count value and the second horizontal count value determine the left limit and the right limit respectively of the window in the video image.

A fourth aspect of the invention relates to a device for decoding information for defining a determined window in a video image to be displayed in a monitor having a cathode ray tube, said information being coded in some at least of R,G,B video signals sent to the monitor. The device comprises means for receiving in a first of these signals a coding pulse synchronized with a horizontal synchronization signal of the cathode ray tube. The coding pulse is received in at least one determined frame within at least one time window associated with a determined frame line. The device also comprises means for counting time units onwards of the start of the frame line. Finally, it comprises means for storing a first horizontal count value on receipt of a start edge of the coding pulse and means for storing a second horizontal count value on receipt of an end edge of the coding pulse. The first horizontal count value and the second horizontal count value determine the left limit and the right limit respectively of the window in the video image.

Finally, a fifth aspect of the invention relates to a video signal comprising R,G,B signals for coding a video image to be displayed in a monitor having a cathode ray tube, and further comprising a horizontal synchronization signal of said cathode ray tube. A first one of said R,G,B video signals comprises a coding pulse in synchronism with said synchronization signal, for coding information for defining a determined window in said video image. The coding pulse is present in at least one frame determined within at least one time window associated with a determined frame line. The coding pulse has a temporal width which corresponds to the width of said window in said video image.

By virtue of the invention, the left and right limits of the window can be determined by the decoding device of the monitor, directly in the reference system tied to the frame. The drawbacks observed in the prior art are thus avoided.

Preferred embodiments allow the decoding device to also determine the upper and lower limits of the window in the reference system of the frame.

### BRIEF DESCRIPTION OF THE DRAWINGS

FIG. 1 is a diagram illustrating the link by video cable between a computer and a CRT monitor;

FIG. 2 is a diagram showing the detail of a video cable;

FIG. 3 is a diagram illustrating a window in a video image, itself on the area of the screen of a monitor;

FIG. 4 is a simplified diagram of a CRT monitor of the prior art comprising a circuit for management of the OSD;

FIG. 5 is a diagram of a device according to an exemplary embodiment of the invention;

FIGS. 6a to 6d are timing diagrams of signals transmitted on a video cable according to the present invention;

FIG. 7, which should be read in conjunction with the timing diagram of FIG. 6a, illustrates the defining of a window in a video image according to the present invention;

FIG. 8 is a diagram illustrating a first exemplary code word transmitted in one of the R,G,B video signals according to the present invention;

FIGS. 9a to 9b are other timing diagrams of signals transmitted on a video cable according to the present invention;

FIG. 9c is a timing diagram representing the state of a status bit generated in the decoding device;

FIGS. 10a to 10d are timing diagrams for signals transmitted on a video cable according to a variant of the invention;

FIG. 11 is a diagram illustrating an example of a first code word transmitted in one of the R,G,B video signals of the said variant;

FIG. 12 is a diagram illustrating an example of a second code word transmitted in one of the RGB video signals of the said variant.

### DETAILED DESCRIPTION OF PREFERRED EMBODIMENTS

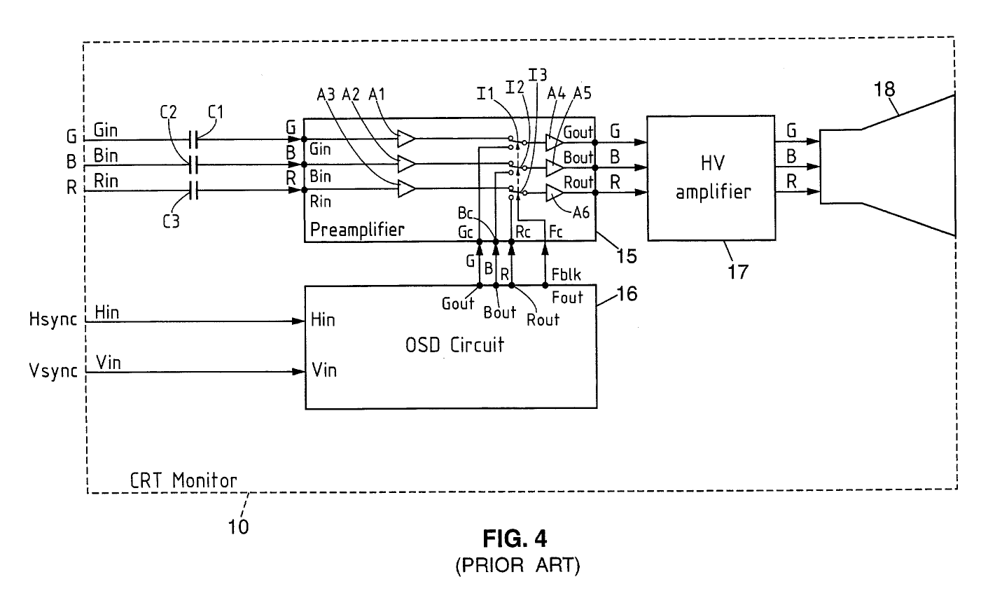

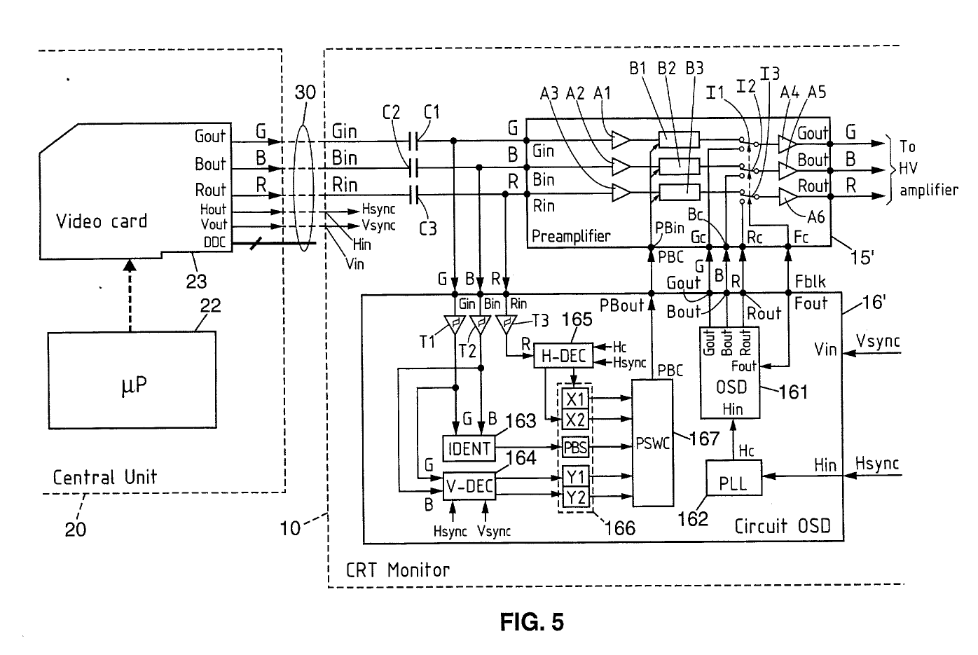

In FIG. 5, in which the same elements as in FIG. 4 bear the same references, the elements of the central unit 20 and of the monitor 10 which are involved in a mode of execution of the invention have been diagrammatically represented.

The central unit 20 comprises a microprocessor 22, and a graphics card or video card 23 controlled by the microprocessor 22. The video card 23 comprises outputs Gout, Bout and Rout for delivering G, B and R video signals respectively. It also comprises outputs Hout and Vout for delivering the Hsync and Vsync synchronization signals. These outputs are connected to a video cable 30 which links the central unit 20 to the monitor 10. The video card 23 also comprises a DDC output port linked to the DDC bus of the video cable 30.

The monitor 10 comprises a preamplifier circuit 15′ and a window management circuit 16′, instead of the circuits 15 and 16 respectively of the monitor 10 of FIG. 4 (prior art).

The preamplifier circuit 15′ is very similar to the circuit 15 represented in FIG. 4. It incorporates all the means thereof described above, and which are not described again here. It comprises an additional input PBin for receiving a control signal PBC. It furthermore comprises adjustment modules B1, B2 and B3 respectively in the first, the second and the third video channel. More specifically, the module B1 is linked between the amplifier A1 and the said first input of the switch I1, the module B2 is linked between the amplifier A2 and said first input of the switch I2, and the module B3 is linked between the amplifier A3 and the said first input of the switch 13. Each of the modules B1, B2 and B3 comprises a control input for receiving the signal PBC. These adjustment modules make it possible to modify the display parameters on the screen of the CRT monitor, when they are activated by the PBC signal. In an example, they make it possible to increase the value of these parameters. In particular, the contrast, the brightness and/or the preaccentuation of the image are increased when these modules are activated.

Advantageously, the preamplifier circuit 15′ of FIG. 5 can be embodied on the basis of the aforesaid STV9211 component from the company STMicroelectronics at the cost of a slight modification thereof.

The circuit 16′ of the CRT monitor of FIG. 5 can also, advantageously, be embodied on the basis of the aforesaid STV9936 component from the company STMicroelectronics, at the cost of a modification thereof. In particular, the circuit 16′ comprises the same inputs and the same outputs as the circuit 16. The functions ensured by the STV9936 circuit relating to the management of the OSD are grouped together in a module 161 or OSD module of the circuit 16′. This module comprises outputs Gout, Bout and Rout which are linked to the outputs Gout, Bout and Rout respectively of the circuit 16′. It further comprises an output Fout which is linked to the output Fout of the circuit 16′ for delivering the signal Fblk. The module 161 does not receive the Hsync and Vsync synchronization signals but receives a clock signal Hc on an input Hin. This clock signal Hc is generated by a PLL (“Phase Locked Loop”) 162 from the horizontal synchronization signal Hsync received on the input Hin of the circuit 16′. The frequency of the clock signal Hc corresponds to the line frequency of the screen of the CRT monitor, that is to say it is related to the number of pixels per line. If appropriate, this frequency therefore depends on the resolution of the screen, when the resolution can be selected by the user. In the case of a VGA screen having 800 lines and 600 columns maximum, there are therefore 600 pulses of the signal Hc for one pulse of the horizontal synchronization signal Hsync.

The circuit 16′ further comprises an identification module 163 or IDENT module, a vertical decoding module 164 or module V-DEC, a horizontal decoding module 165 or H-DEC module, a memory module 166 comprising an assembly of registers, and a window management circuit 167 or PBWC circuit (standing for “Picture Boost Window Control”).

The G and B video signals received on the inputs Gin and Bin respectively of the circuit 16′ are sent to the identification module 163 and to the vertical decoding module 164, each by way of a Schmitt trigger, T1 and T2 respectively. The V-DEC module receives the horizontal Hsync and vertical Vsync synchronization signals. As will become apparent hereinbelow, this module makes it possible to extract from the G and B video signals, values Y1′ and Y2′ which are associated with the upper limit and with the lower limit, respectively, of the window 14 in the video image 13. These values Y1′ and Y2′ are expressed in the reference system tied to the frame. They are stored in appropriate registers of the memory module 166.

The IDENT module has the function of decoding a code word which is transmitted in the G video signal, this decoding being performed on the basis of the pulses of a clock signal which are transmitted in the video signal B. The aforesaid code word and pulses of the clock signal are transmitted in synchronism with the horizontal synchronization signal Hsync in at least one determined frame, within at least one time window associated with a determined frame line. The identification module 163 then produces a PBS bit having a determined value, for example the value 1 when a function bit of the code word exhibits a determined value, for example the value 1 and, inversely, produces the PBS bit having the value 0 when the function bit of the code word has the value 0.

The H-DEC module receives the R video signal which is received by the input Rin of the circuit 16′ by way of a Schmitt trigger T3. Moreover, this H-DEC module receives the clock signal Hc and the horizontal synchronization signal Hsync. The H-DEC module has the function of extracting from the R video signal, as will become apparent in what follows, values X1′ and X2′ respectively associated with the left limit and with the right limit of the window 14 in the video image 13. These values X1′ and X2′ are expressed in the reference system tied to the frame. They are stored in suitable registers of the memory of the memory module 166.

The PBWC circuit accesses the values stored in the aforesaid registers of the memory module 166. On the basis of the values X1′, X2′, PBS, Y1′ and Y2′, it then generates a control signal PBC which is delivered on an output PBout of the circuit 16′. It is recalled that the PBC signal makes it possible to control the modification of the parameters for displaying the image on the screen of the CRT monitor, by virtue of the adjustment modules B1, B2 and B3 of the preamplifier circuit 15′.

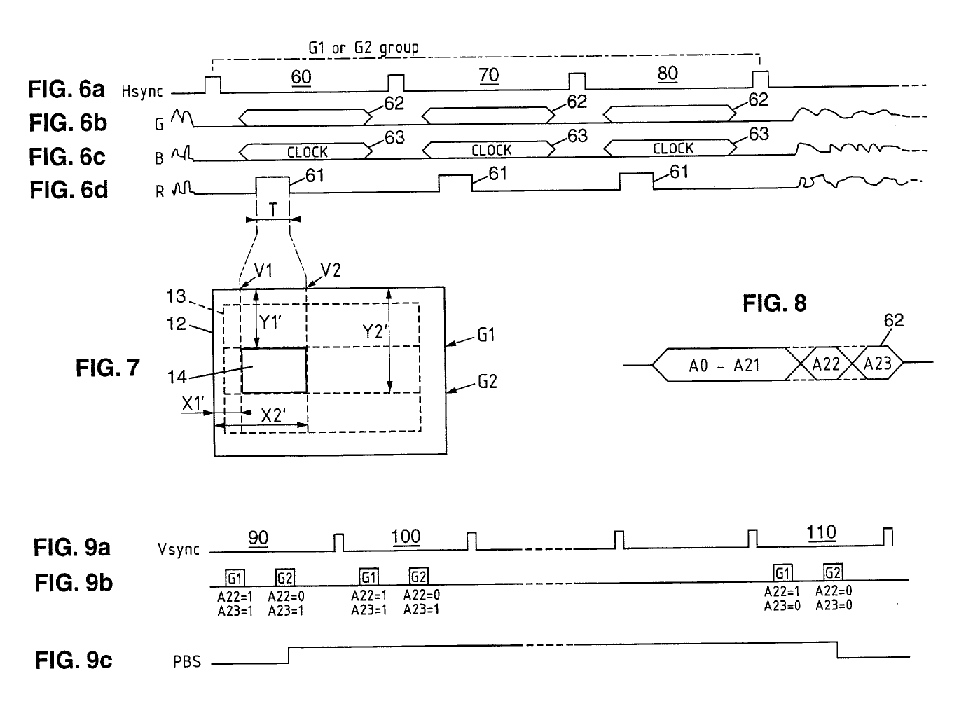

A process for coding and a process for decoding information for displaying a determined window 14 in a video image 13 will now be described. This description is given with reference to the timing diagrams of FIGS. 6a-6d and 9a-9d, and to the diagrams of FIGS. 7 and 8.

The process for coding the information is implemented in the video card 23, by an appropriate coding device. The process for decoding the information is implemented in the monitor 10, by an appropriate decoding device. Advantageously, this decoding device is contained in the circuit 16′ also ensuring the management of the OSD function of the monitor, which was described earlier in conjunction with the diagram of FIG. 5. Thus, the invention does not require the addition into the monitor 10 of a component specifically dedicated to the dynamic management of the displaying of a window in the video image. It may be implemented through a straightforward adaptation of a known component, namely the OSD circuit depicted under the reference 15 in FIG. 4.

The position and the dimensions of the window 14 are fully determined by the aforesaid coordinate values X1′, X2′, Y1′ and Y2′, which are expressed in the reference system tied to the frame. These values are determined by the video card 23, on the basis of the coordinate values X1, X2, Y1 and Y2 which were defined in the introduction with reference to the diagram of FIG. 3. It is recalled that these latter values are produced by the application software executed by the microprocessor 22 of the central unit 20. The coordinate values X1′, X2′, Y1′ and Y2′ are illustrated in the diagram of FIG. 7, by arrows between the borders of the window 14 and the corresponding borders of the area 12 of the screen of the monitor 11. In FIG. 7, the video window 13 is indicated dashed.

FIG. 6a shows the profile of the horizontal synchronization signal Hsync of the cathode ray tube of the CRT monitor. Visible in particular are the determined time windows 60, 70 and 80, each of which lies between two consecutive pulses of the signal Hsync. These windows are associated with determined frame lines. This is why the expression “frame line” or the term “line” will also be used in what follows to designate the time windows 60, 70 and 80. In the example, the frame lines 60, 70 and 80 are consecutive.

FIGS. 6b, 6c and 6d show respectively the R, G and B video signals before, during and after the time windows 60, 70 and 80.

During coding, a coding pulse 61 is transmitted in one of the R,G,B video signals sent to the monitor 10 via the video cable 30, for example in the signal R, in synchronism with the signal Hsync. The coding pulse 61 is transmitted in at least one frame within at least one time window associated with a determined frame line. In the example, it is transmitted in the time windows 60, 70 and 80.

The coding pulse 61 has a temporal width T which corresponds to the width of the window 14 in the video image 13, that is to say to the difference between the aforesaid values X2′ and X1′.

A start edge of the coding pulse 61 (a rising edge in the example represented) corresponds for example to the left limit (defined by the value X1′) of the window 14 in the video image 13. Likewise, an end edge of the coding pulse 61 (a falling edge in the example represented) corresponds to its right limit (defined by the value X2′) in the video image 13. This is not compulsory however. Specifically, the left and right limits of the window 14 in the video image 13 need not correspond to the instants of occurrence of the start and end edges of the coding pulse 61 but may stem therefrom through a determined time shift known to the decoding device.

In one mode of implementation, the frame line or lines in which the coding pulse 61 is transmitted are lines of the video image, that is to say they are displayed on the screen of the monitor.

During coding, a code word 62 is also transmitted in another of the R,G,B video signals sent to the monitor 10 via the video cable 30, for example in the signal G (FIG. 6b), in synchronism with the signal Hsync. This code word 62 is transmitted in a given number m of determined frames, where m is a non-zero integer number. In each of said m frames, the code word 62 is transmitted a given number n1 of times, where n1 is a non-zero integer number, within n1 first respective time windows, respectively associated with n1 lines of a first group G1 of determined frame lines.

It is further advantageous to transmit in the last of the R,G,B video signals (that is in the B signal according to the example considered here, see FIG. 6c), a clock pulse train 63 which is in synchronism with the signal Hsync, in each of the time windows in which the code word 62 is transmitted. These clock pulses have the function of allowing the decoding of the code word 62 by the decoding device 16′ of the monitor 10.

As is illustrated in the diagram of FIG. 8, the code word 62 comprises a given number N of identification bits and a given number M of function bits, where N and M are integer numbers. In an example, N is equal to 22 (N=22) and M is equal to two (M=2). The function of the 22 identification bits A0 to A21, is to allow the decoding device to distinguish it from the analogue data which are transmitted in the G video signal outside of the time windows in which it is transmitted. The two function bits comprise a bit A22, to which we shall return below. They also comprise a bit A23 which is the function bit which was already mentioned earlier.

The identification bits A0-A21 determine an identification code having, for each occurrence of the code word, a determined value known to the decoding device 16′ of the monitor 10.

When n1 is equal to 3, the identification code of the code words transmitted in the time windows 60 and 80 which are associated respectively with the first and with the third of the lines of the first group G1 of the frame lines has a determined value \overline{U}, and the code word transmitted in the time window 70 which is associated with the second of the lines of the first group G1 has the value U which is the logical complement of the said determined value. The fact that the value of the identification code changes with each of the n1 occurrences of the code word 62 makes the device more robust with regard to decoding errors. The fact that it takes only two values U and \overline{U} which are the logical complement of one another makes it possible to simplify the decoding device, since it is sufficient to store one of these values in an ad-hoc register and to generate the other with the aid of simple inverters.

In the first embodiment, the n1 lines of the group G1 are lines of the video image, that is to say they are displayed on the screen of the monitor 10. For sure, this may be perceived as a drawback of the invention, but it will be understood on reading what follows that the lines concerned are very few in number. This drawback is therefore not crippling. Moreover, it may be exploited in order to afford a pleasant visual effect in the image corresponding to the frame in which the code word is sent.

When n1 is strictly greater than unity, the n1 lines of the first group G1 of the frame lines are preferably consecutive lines of the frame. Thus, the n1 lines displayed produce on the screen a horizontal band having a certain width (along the vertical), the visual effect of which is preferable to that which an isolated line would produce. Specifically, an isolated line may appear as a defect, while a band may on the contrary appear as a fancy display effect.

In an exemplary embodiment in accordance with FIGS. 6a-6d, the number n1 is equal to 3. Thus the code word 62 is received three times by the associated decoding device, namely in the time windows 60, 70 and 80 in the example represented. Thus, the chances of decoding it correctly are multiplied by three. Moreover, the band produced by the displaying of these three lines then exhibits a satisfactory width, from a visual point of view. However, the number n1 may also be equal to unity. Specifically, the code word 62 need only be received once by the decoding device. In this case, of course, the group of lines G1 is reduced to a single line.

The n1 lines of the group G1 have the function of determining the upper limit (defined by the value Y1′) of the window 14 in the video image 13. More specifically it is the position of these lines in the frame (that is to say the instant of occurrence of the associated time windows with respect to the start of the frame) which determines this upper limit. This will become more clearly apparent later, when the information decoding process is described.

Optionally or additionally, the code word 62 is further transmitted n2 times in each of the said m frames, where n2 is a non-zero integer number, within n2 second respective time windows, respectively associated with n2 lines of a second group G2 of determined frame lines. These n2 frame lines of the second group G2 are, in this example, also lines of the video image. They are distinct from the n1 frame lines of the first group of frame lines. Moreover, they have the function of determining the lower limit (defined by the value Y2′) of the window 14 in the video image 13, in the same way as the lines of the first group G1 determine the upper limit of this window.

In certain applications, it may be enough to transmit the n1 lines of the first group G1 of frame lines. The lower limit of the window 14 can then be determined from the value Y1′, for example by adding a determined number of lines to it. It may also be enough to transmit the n2 lines of the second group G2 of frame lines. The upper limit of the window 14 can then be determined from the value Y2′, for example by subtracting a determined number of lines from it. In both cases, the window 14 then has a fixed height, defined by the said determined number of lines.

To obtain a window whose height can be defined dynamically by the application program executed by the microprocessor 22 of the central unit 20, it is nevertheless preferable to transmit both the n1 lines of the first group G1 of frame lines and the n2 lines of the second group G2 of frame lines.

In an exemplary embodiment, the number m is equal to 2. Thus, the groups of frame lines G1 and G2 are transmitted twice, in two distinct frames. Preferably, these are two consecutive frames of the video information stream. Thus, if the decoding has failed for the n1 and/or n2 occurrences of the code word 62 of a frame, it may be attempted again during the next frame.

FIG. 9a shows the profile of the vertical synchronization signal Vsync for the cathode ray tube of the monitor 10. Visible in particular are determined time windows 90, 100 and 110, each lying between two consecutive pulses of the signal Vsync. These windows are associated with determined frames. This is why the term “frame” will also be used in what follows to designate time windows 90, 100 and 110. In the example, the frames 90 and 100 are consecutive, and there is an undetermined number of frames between frame 100 and frame 110. This number is associated with the duration of display of the window 14, which depends on the application.

As is depicted in the diagram of FIG. 9b, the function bit A22 has a first determined value, for example the value 1, for the code words 62 transmitted in the n1 lines of the first group G1. Conversely, it has a second determined value, for example the value 0, for the code words 62 transmitted in the n2 lines of the first group G2. As will be apparent later, it is the value of this bit A8 which lets the decoding device know whether it is in the process of decoding the value Y1′ or the value Y2′, respectively associated with the upper limit and the lower limit of the window 14.

Further the function bit A23 of the code word 62 has a first determined value, for example the value 1, to activate a command for modifying the display parameters in the window with respect to the remainder of the video image (via the PBS signal visible in FIG. 5), and has the value 0 to deactivate this command. In an exemplary embodiment illustrated by FIG. 9b, the code word 62 which is transmitted in the frame lines of the groups G1 and G2 of the frames 90 and 100 has the bit A23 at the value 1, and that which is transmitted in the lines of the groups G1 and G2 of the frame 110 has the bit A23 at the value 0.

Preferably, when n2 is strictly greater than unity, the n2 lines of the second group G2 are consecutive lines of the frame. In an advantageous embodiment, the number n2 is equal to three. The identification code of the code words transmitted in the time windows which are associated respectively with the first and with the third of the lines of the second group G2 then preferably has a determined value \overline{U}, while the code word transmitted in the time window which is associated with the second of the lines of the second group has the value U which is the logical complement of the said determined value \overline{U}. The motives for these features are the same as those set forth above in regard to the lines of the first group G1.

Also preferably, the coding pulse 61 is transmitted in each of the n1 first time windows and/or in each of the n2 second time windows. Thus, the resulting colour of the n1 lines of the first group G1 is identical for each of these lines, and likewise for the n2 lines of the second group G2. Moreover, for each frame such as 90 and 100, the colour of the lines of the first group G1 is very similar to that of the lines of the second group G2, since it differs only by the effect of the distinct value of the function bit A22.

The method and the device for decoding the information received coded in the R,G,B video signals, for defining the window 14 in the video image 13, will now be described. This decoding is implemented in the monitor. Preferably, it is implemented in the circuit 16′ described above with reference to the diagram of FIG. 5.

In an exemplary embodiment, the horizontal decoding circuit H-DEC is derived from a counter, a counting input of which receives the signal Hc and a reset to zero input of which receives the signal Hsync. In this way, the H-DEC circuit counts time units respectively associated with a pixel of the image, from a zero value corresponding each time to the start of the frame line.

A first horizontal count value is stored in one of the registers of the memory module 166 on receipt of the start edge of the coding pulse 61, that is to say of the rising edge of this pulse in the example. In an example, this first horizontal count value corresponds to the value X1′, that is to say to the left border of the window 14 in the video image 13.

Further, a second horizontal count value is stored in yet another of the registers of the memory module 166 on receipt of the end edge of the coding pulse 61. In an exemplary embodiment, this second horizontal count value corresponds to the value X2′, that is to the right border of the window 13 in the video image 14.

As already mentioned, it is not compulsory for the said first and second horizontal count values to correspond directly to the values X1′ and X2′. Specifically, they may only indirectly determine these values X1′ and X2′, when the latter are obtained from, respectively, the first and second horizontal count values by adding or subtracting a determined respective value.

In all cases, the values X1′ and X2′ are advantageously expressed directly in the reference system of the monitor 10, since the counter is reset to zero by the Hsync signal.

The vertical decoding circuit V-DEC is derived from a counter, a counting input of which receives the Hsync signal and a reset to zero input of which receives the Vsync signal. In this way, the V-DEC circuit counts the lines of the frame, from a zero value corresponding each time to the start of the frame.

A first vertical count value is stored in another of the registers of the memory module 166 on receipt of the determined one of the n1 occurrences of the code word 62 with the function bit A22 having the first determined value envisaged in the example, namely 1. In an exemplary embodiment, this first vertical count value corresponds to the value Y1′, that is to the upper limit of the window 13 in the video image 14. When the number n1 is equal to 3, the first vertical count value is for example thus stored when the second occurrence of the code word 62 is received.

Further, a second vertical count value is stored in another of the registers of the memory module 166 on receipt of the determined one of the n2 occurrences of the code word 62 with the function bit A22 having the second determined value envisaged in the example, namely 0. In an exemplary embodiment, this second vertical count value corresponds to the value Y2′, that is to the lower limit of the window 13 of the video image 14. In an example, when the number n2 is equal to 3, the second vertical count value is thus stored when the first occurrence of the code word 62 is received.

Here again, it is not compulsory for the said first and second vertical count values to correspond directly to the values Y1′ and Y2′. Specifically, they may only indirectly determine these values Y1′ and Y2′, when the latter are obtained from, respectively, the first and second vertical count values by adding or subtracting a determined respective value.

The identification module IDENT also receives the code word 62 in the G video signal. It decodes the function bit A23 of this code word. When the bit A23 has the first determined value envisaged in the example (that is the value 1), it activates the command for modifying the display parameters in the window 14 with respect to their values in the remainder of the video image 13, by toggling the PBS status bit to 1. In an example, this is carried out by storing the value PBS=1 in another register of the memory module 166. On the other hand, when the bit A23 has the second determined value envisaged in the example (that is the value 0), it deactivates the said command for modifying the display parameters, by toggling the PBS status bit to 0. In an example, this is carried out by storing the value PBS=0 in the above-mentioned register of the memory module. The alterations over time of the state of the PBS status bit are thus represented by the timing diagram of FIG. 9c.

The values X1′, X2′, Y1′ and Y2′ are stored in the aforesaid corresponding registers of the memory module 166, while the PBS status bit has the value 1. They are erased when the PBS status bit toggles to the value 0. Thus, they are maintained for all the frames lying between frame 90 (or frame 100 if the decoding is effected properly only upon receipt of the information coded in the video signals within the frame 100 although it failed for frame 90) on the one hand, and frame 110 on the other hand. For all these frames, the display parameters are modified for the displaying of the pixels lying in the window 14, with respect to their value for the displaying of the pixels of the remainder of the video image 13. This results from the switching of the PBC signal by the PBWC module of the circuit 16′ on the one hand, and from the action of the control modules B1-B3 of the preamplifier 15′ on the other hand.

The circuit 16′ receives in the B video signal the clock pulse train 63, in each of the time windows in which the code word 62 is received. These clock pulses are used for decoding said code word, both by the vertical decoding module V-DEC and by the identification module IDENT.

It will be noted that the decoding of the code word 62, both by the vertical decoding module V-DEC and by the identification module IDENT, comprises the verification of the value of the identification code defined by the bits A0-A21 of the code word. This verification makes it possible to prevent the device from reacting wrongly, in response to analogue levels in the R,G,B video signals which might coincide with the coded information for defining the window 14.

It is recalled that this identification code advantageously has one of the values \overline{U} and U, which are logically complementary to one another, according to the occurrence of the relevant code word among the n1 and/or the n2 occurrences of this code word in a give frame. This is advantageous since only one of these values need be stored by the decoding device. In certain applications, this value may be defined by the user, or be sent dynamically to the device 16′ by the application program executed by the microprocessor 22 of the central unit via the DDC bus for example. Other values of the identification code may also be provided, so as for example to code other functions.

It is thus possible to use several distinct values of the identification code to manage the displaying of several distinct windows simultaneously in the video image 13. In this case, the identification codes are sent dynamically to the decoding device 16′ by the video card 23, for example via the DDC bus of the video cable or another bus (for example a USB bus) linking the central unit 20 to the monitor 10.

As a variant or as an adjunct, other functions may also be coded in the G video signal by virtue of the additional bits of the code word 62 which are similar to the function bits A22 and A23 (in this case, M is greater than two).

The n1 lines of the first group of frame lines G1 and/or the n2 lines of the second group of frame lines G2 being lines of the video image 13, these lines are visible on the screen of the monitor. In an example, they are displayed without masking. These groups of lines G1 and G2 appear as horizontal bands represented symbolically in FIG. 7, at the upper and lower limit of the window 14. Advantageously, groups of lines V1 and V2 forming vertical bands, likewise represented symbolically in FIG. 7, are at the same time displayed at the left and right limit of the window 14. A visual effect of underlining of the limits of the window 14 is thus obtained.

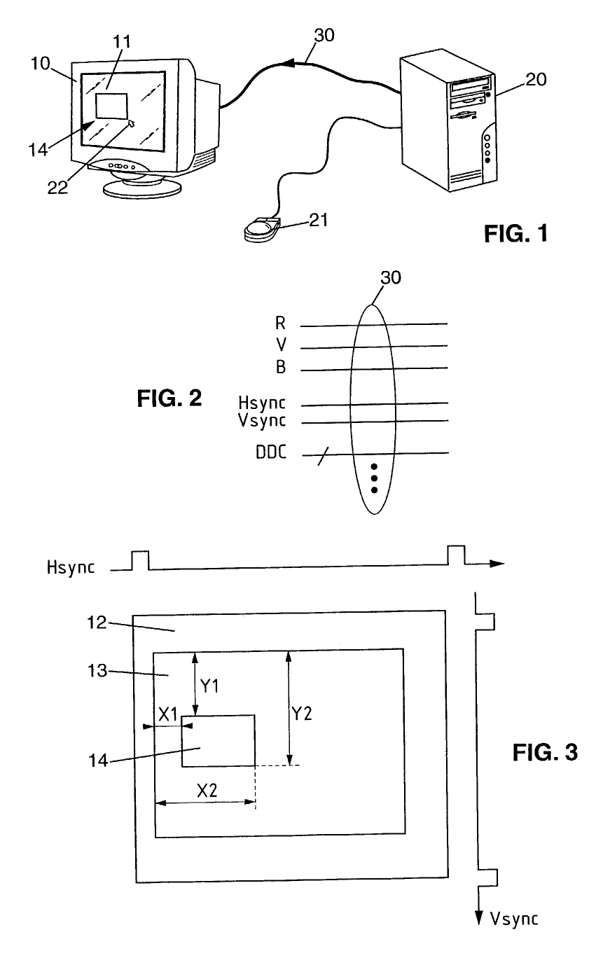

The vertical lines of the groups V1 and V2 are generated by the application program and their position in the video image are calculated as soon as the defining of the window 14 with the aid of the mouse 21 (FIG. 1) has finished. They are displayed at the same time as the horizontal lines of the groups G1 and G2, that is for the video frames containing these lines.

It will be noted that these horizontal and vertical bands are visible, at most, only for the frames in which the information relating to the defining of the window 14 are received by the monitor. In particular, they are not visible between frame 100 and frame 110 (FIG. 9b).

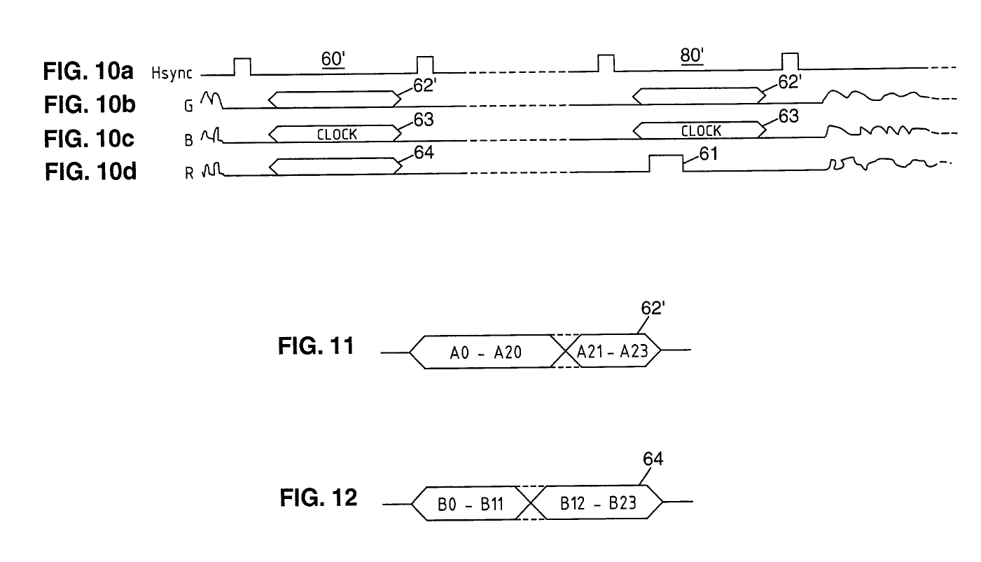

In a variant of the method, which is illustrated by FIGS. 10a-10d and 11, a first code word 62′ is transmitted p times in p determined frames (where p is an integer number, for example greater than or equal to two) in one of the R,G,B video signals in synchronism with the Hsync signal (FIG. 10a), for example the G signal (FIG. 10b). Each time, the code word is transmitted within a time window 60′ associated with the first line of the video image. Stated otherwise, the code word 62′ is transmitted p times, in p determined frames, within p time windows respectively associated with the first line of the corresponding video image, such as for example the windows denoted 60′ and 80′ in FIG. 10a. This first code word 62′ is comparable to the code word 62 of the previous exemplary embodiment. In this variant, N is for example equal to 21 (N=21) and M is for example equal to 3 (M=3). In addition to the identification code defined by the 21 identification bits A0-A20, the code word 62′ therefore comprises a function word coded by the 3 function bits A21-A23. The first code word 62′ transmitted according to this variant is represented diagrammatically in FIG. 11.

The defining of the window 14 in the video image 13 is achieved in two phases, by virtue of the information sent in another of the R,G,B signals, for example in the R signal (FIG. 10d).

In a first phase, a second code word 64 is transmitted q1 times, where q1 is an integer number less than p, in the R signal. Each time, the code word 64 is transmitted within a time window in which the code word 62′ is transmitted, for example, the window 60′. Stated otherwise, the q1 time windows in which the second code word 64 is transmitted lie in the p time windows in which the first code word 62′ is transmitted.

In order to allow the decoding device to know when this second code word 64 is transmitted and thus to be able to decode it correctly, the first code word 62′ contains a function code (defined by the bits A21-A23) which is equal to a first determined value, known to the said device. For example, this first value is equal to 001 in binary, that is the bits A21, A22 and A23 have the value 0, the value 0 and the value 1 respectively.

The second code word 64 comprises for example K bits, where K is an integer number for example equal to 24 (K=24). These 24 bits encode a first and a second value. They comprise for example twelve first bits B0-B11 which encode the said first value and twelve second bits B12-B23 which encode the said second value. The second code word is represented diagrammatically in FIG. 12.

The first value determines the upper limit of the window 14 in the video image 13 with respect to the first line of the video image. The second value determines the lower limit of the window 14 in the video image 13 with respect to the said first line of the video image. Stated otherwise, these first and second values are expressed as a number of frame lines, in a reference system tied to the video image, the zero value corresponding to the first line of the video image.

Advantageously, the first and/or the second value correspond for example, respectively to the value Y1 and to the value Y2 presented in the introduction in conjunction with FIG. 3, that is to the upper and lower limits respectively of the window 14, expressed in the reference system of the video image. Nevertheless, it is possible for the said upper and lower limits respectively of the window 14 to be deduced from the said first and second values received by the decoding device in the code word 62, by shifting by one or more lines plus-wise or minus-wise.

The values Y1′ and Y2′, corresponding to the upper and lower limits of the window in the reference system tied to the frame, may be easily obtained by adding the values Y1 and Y2 respectively, to the current value of the counter of the V-DEC module when the second code word 64 is received.

In a second phase, the coding pulse signal 61 is transmitted q2 times, where q2 is an integer number less than p, in the R video signal (FIG. 10d). Each time, the code word 64 is transmitted within a time window, such as the window 80′ in which the code word 62′ is transmitted and in which the second code word 64 is not transmitted. Stated otherwise, the q2 time windows in which the coding pulse 61 is transmitted lie in the p time windows in which the first code word 62′ is transmitted, and are distinct from the q1 time windows in which the second code word is transmitted. Preferably, p is equal to q1 plus q2 (p=q1+q2).

The decoding of this pulse 61 allows the decoding device to ascertain the left limit X1′ and the right limit X2′ of the window 14 in the video image 13, in the same way as in the first mode of implementation described above.

In order to allow the decoding device to know when the coding pulse 61 is transmitted in the R video signal, and thus to be able to decode it correctly, the first code word 62′ contains a function code (defined by the bits A21-A23) which is equal to a second determined value, known to the said device. For example, this second value is equal to 010 in binary, that is to say the bits A21, A22 and A23 have the value 0, the value 1 and the value 0 respectively.

In this variant, the command for modifying the display parameters is activated when the function code defined by the bits A21-A23 is received by the decoding device with the aforesaid binary value 010. The PBS status bit is then set to 1, in the example.

To deactivate the command for modifying the display parameters, the code word 62′ is transmitted in the G video signal (still in a time window associated with the first line of the video image 13), with an identification code (defined by the bits A21-A23) having a third determined value known to the decoding device, for example the zero value 000 in binary, that is the bits A21, A22 and A23 each have the value 0.

In this variant, the clock pulse train 63 is also transmitted in another of the R,G,B video signals, namely in the B signal in the example, in each of the time windows such as 60′ and 80′ in which the first code word 62′ is transmitted (FIG. 10c). This pulse train is used by the decoding device for the decoding of the code word 62′, but also for the decoding of the second code word 64 when it is transmitted.

One of the advantages of this variant is that the first line of the video image can be masked by the decoding device during the sending of the data defining the window and/or the activating and the deactivating of the command for modifying the display parameters, so that it is not visible on the screen 11 of the monitor 10. In this way, the sending of data defining the window 14 is irrelevant to the image displayed.

Preferably the second code word 64 and the coding pulse are each transmitted in at least two distinct frames, for example two consecutive frames. Thus, the risk of nondetection or of wrong decoding of the information for defining the window is reduced. Stated otherwise, q1 is greater than or equal to two. For example equal to two (q1=2). Likewise q2 is greater than or equal to two. For example it is equal to two (q2=2). The first and the second phases hereinabove then each correspond to two consecutive frames. In this example, p is then greater than or equal to four and is for example equal to four (p=4).

There may be one or more frames sent between the two aforesaid phases, that is, in the example, between the transmission of the two occurrences of the second code word 64 and the transmission of the two occurrences of the coding pulse 61. However, these occurrences preferably arise in p consecutive frames, four in number in the example. The time during which the first line of the video image 13 is masked is thus limited.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. Method for coding information for defining a determined window (14) in a video image (13) to be displayed in a monitor having a cathode ray tube, comprising the step of transmitting a coding pulse in synchronism with a horizontal synchronization signal of said cathode ray tube, in a first one of R,G,B video signals sent to said monitor
wherein said coding pulse is transmitted in at least one frame determined within at least one time window associated with a determined frame line, and
wherein said coding pulse has a temporal width which corresponds to the width of said window in said video image.

2. The coding method of claim 1, wherein a start edge of the coding pulse corresponds to the left limit of the window in the video image, and wherein an end edge of the coding pulse corresponds to the right limit of said window.

3. The coding method of claim 1 further comprising the step of transmitting a code word in a second one of the R,G,B video signals in synchronism with the horizontal synchronization signal, said code word being transmitted in a given number m of determined frames, where m is a non-zero integer number, and being transmitted a given number n1 of times in each of said m frames, where n1 is a non-zero integer number, within n1 first respective time windows, respectively associated with n1 lines of a first group of determined frame lines which are lines of the video image and which determine the upper limit of the window in the video image.

4. The coding method of claim 3 further comprising the step of transmitting the code word a given number n2 of times in each of the m frames, where n2 is a non-zero integer number, within n2 second respective time windows, respectively associated with n2 lines of a second group of determined frame lines which are lines of the video image distinct from the n1 frame lines of the first group of frame lines in which the code word is transmitted, and which determine the lower limit of the window in the video image.

5. The coding method of claim 3 wherein n1 is strictly greater than unity, and wherein the n1 lines of the first group of frame lines are consecutive lines of the frame.

6. The coding method of claim 4 wherein n2 is strictly greater than unity, and wherein the n2 lines of the second group are consecutive lines of the frame.

7. The coding method of claim 3 wherein the code word comprises identification bits which determine an identification code having for each occurrence of the code word a determined value known to a decoding device of the monitor.

8. The coding method of claim 3 wherein n1 is equal to 3, and wherein the identification code of the code words transmitted in those of the first time windows which are associated respectively with the first one and with the third one of the lines of the first group of frame lines has a first determined value whereas the code word transmitted in that of the first time windows which is associated with the second one of the lines of the first group has a second determined value which is the logical complement of said first determined value.

9. The coding method of claim 4, wherein n2 is equal to 3, and wherein the identification code of the code words transmitted in those of the second time windows which are associated respectively with the first one and with the third one of the lines of the second group has a first determined value whereas the code word transmitted in that of the second time windows which is associated with the second one of the lines of the second group has a second determined value which is the logical complement of the said first determined value.

10. The coding method of claim 4, wherein the code word further comprises at least one first function bit, and wherein said first function bit of the code words transmitted in the n1 first time windows associated with the n1 lines of the first group have a first determined value, whereas the said first function bit of the code words transmitted in the n2 second time windows associated with the n2 lines of the second group have a second determined value.

11. The coding method of claim 4, wherein the code word further comprises at least one second function bit having a first determined value so as to activate a command for modifying display parameters in the window with respect to the remainder of the video image, and having a second determined value for deactivating said command.

12. The coding method of claim 3 further comprising the step of transmitting clock pulses in synchronism with the horizontal synchronization signal in a third one of the R,G,B video signals, in each of the time windows in which the code word is transmitted.

13. The coding method of claim 3 wherein the coding pulse is transmitted in each of the time windows in which the code word is transmitted.

14. The Coding method of claim 3, wherein m is equal to 2.

15. The coding method of claim 1 further comprising the step of transmitting a first code word in synchronism with the horizontal synchronization signal in a second of the R,G,B video signals, wherein said first code word is transmitted a given number p of times, in p determined frames, where p is an integer number, within p time windows respectively associated with the first line of the corresponding video image, and wherein said first code word comprises a given number N of bits defining an identification code and, further comprising a given number M of bits defining a function word, where N and M are integer numbers.

16. The coding method of claim 15, further comprising the step of transmitting a second code word in synchronism with the horizontal synchronization signal in a third one of the R,G,B video signals, wherein said second code word is transmitted in a given number q1 of determined time windows lying in said p time windows in which the first code word is transmitted, and wherein said second code word comprises a given number K of bits, where K is an integer number, which K bits encode a first value which determines the upper limit of the window in the video image with respect to the first line of the video image, as well as a second value which determines the lower limit of said window in the video image with respect to the first line of the video image.

17. The coding method of claim 16, wherein the coding pulse is transmitted a given number q2 of times in q2 determined time windows, lying in the p time windows in which the first code word is transmitted and distinct from the q1 time windows in which the second code word is transmitted.

18. The coding method of claim 15 further comprising the step of transmitting clocks pulses in synchronism with the horizontal synchronization signal in a third one of the R,G,B video signals, in each of the time windows in which the first code word is transmitted.

19. The coding method of claim 16 further comprising the step of transmitting clock pulses in synchronism with the horizontal synchronization signal in a third one of the R,G,B video signals, in each of the time windows in which the second code word is transmitted.

20. The coding method of claim 15, wherein p is equal to 4.

21. The coding method of claim 16, wherein q1 is equal to 2.

22. The coding method of claim 17, wherein q2 is equal to 2.

23. Device for coding information for defining a determined window in a video image to be displayed in a monitor having a cathode ray tube, comprising means for transmitting, in a first one of R,G,B video signals sent to the monitor, and, in at least one frame determined within at least one time window associated with a determined frame line, a coding pulse synchronized with a horizontal synchronization signal of said cathode ray tube, said coding pulse having a temporal width which corresponds to the width of the said window in the said video image.

24. The coding device of claim 23, wherein a start edge of the coding pulse corresponds to the left limit of the window in the video image, and wherein an end edge of the coding pulse corresponds to the right limit of window in the video image.

25. The coding device of claim 19 further comprising means for transmitting a code word in a second one of the R,G,B video signals, in synchronism with the horizontal synchronization signal of the cathode ray tube, in a given number m of determined frames, where m is a non-zero integer number, and a given number n1 of times in each of said m frames, where n1 is a non-zero integer number, within n1 first respective time windows, respectively associated with n1 lines of a first group of determined frame lines which are lines of the video image and which determine the upper limit of the window in the video image.

26. The coding device of claims 25, further comprising means for transmitting the code word a given number n2 of times in each of the m frames, where n2 is a non-zero integer number, within n2 second respective time windows, respectively associated with n2 lines of a second group of determined frame lines which are lines of the video image which are distinct from the n1 frame lines of the first group of frame lines in which the code word is transmitted, and which determine the lower limit of the window in the video image.

27. The coding device of claim 25 wherein n1 is strictly greater than unity, and wherein the n1 lines of the first group of frame lines are consecutive lines of the frame.

28. The coding device of claim 26 wherein n2 is strictly greater than unity, and wherein the n2 lines of the second group are consecutive lines of the frame.

29. The coding device of claim 25, wherein the code word comprises identification bits which determine an identification code having for each occurrence of the code word a determined value known to a decoding device of the monitor.

30. The coding device of claim 25, wherein n1 is equal to 3, and wherein the identification code of the code words transmitted in those of the first time windows which are associated respectively with the first one and with the third one of the lines of the first group of frame lines has a determined value whereas the code word transmitted in that of the first time windows which is associated with the second of the lines of the first group has a value which is the logical complement of said determined value.

31. The coding device of claim 26, wherein n2 is equal to 3, and wherein the identification code of the code words transmitted in those of the second time windows which are associated respectively with the first one and with the third one of the lines of the second group has a determined value whereas the code word transmitted in that of the second time windows which is associated with the second one of the lines of the second group has a value which is the logical complement of said determined value.

32. The coding device of claim 26, wherein the code word further comprises at least one first function bit, and wherein said first function bit of the code words transmitted in the n1 first time windows associated with the n1 lines of the first group have a first determined value whereas said first function bit of the code words transmitted in the n2 second time windows associated with the n2 lines of the second group have a second determined value.

33. The coding device of claim 26, wherein the code word further comprises at least one second function bit having a first determined value so as to activate a command for modifying the value of display parameters in the window, and having a second determined value for deactivating the said command.

34. The coding device of claim 26 further comprising means for transmitting in a third one of the R,G,B video signals clock pulses in synchronism with the horizontal scanning signal of the cathode ray tube, in each of the time windows in which the code word is transmitted.

35. The coding device of claim 26 further comprising means for transmitting the coding pulse in each of the time windows in which the code word is transmitted.

36. The coding device of claim 26 wherein m is equal to 2.

37. The coding device of claim 23 further comprising means for transmitting a first code word in synchronism with the horizontal synchronization signal in a second one of the R,G,B video signals, wherein said first code word is transmitted a given number p of times, in p determined frames, where p is an integer number, within p time windows respectively associated with the first line of the corresponding video image, and wherein said first code word comprises a given number N of bits defining an identification code and further comprises a given number M of bits defining a function word, where N and M are integer numbers.

38. The coding device of claim 37 further comprising means for transmitting a second code word in synchronism with the horizontal synchronization signal in a third one of the R,G,B video signals, wherein said second code word is transmitted in a given number q1 of determined time windows lying in the p time windows in which the first code word is transmitted, and wherein said second code word comprises a given number K of bits, where K is an integer number, which encode a first value which determines the upper limit of the window in the video image with respect to the first line of the video image, as well as a second value which determines the lower limit of said window in said video image with respect to the first line of said video image.

39. The coding device of claim 38, wherein the coding pulse is transmitted a given number q2 of times in q2 determined time windows, lying in the p time windows in which the first code word is transmitted and distinct from the q1 time windows in which the second code number is transmitted.

40. The device of claim 37, further comprising means for transmitting a clock pulse train in synchronism with the horizontal synchronization signal in a third one of the R,G,B video signals, in each of the time windows in which the first code word is transmitted and/or the second code word (64) are transmitted.

41. The device of claim 38, further comprising means for transmitting clock pulses in synchronism with the horizontal synchronization signal in a third one of the R,G,B video signals, in each of the time windows in which the second code word is transmitted.

42. The coding device of claim 37 wherein p is equal to 4.

43. The coding device of claim 38 wherein q1 is equal to 2.

44. The coding device of claim 39 wherein q2 is equal to 2.

45. Method for decoding information for defining a determined window in a video image to be displayed in a monitor having a cathode ray tube, said information being coded in some at least of R,G,B video signals sent to the monitor, comprising the steps of
receiving a coding pulse synchronized with a horizontal synchronization signal of the cathode ray tube in a first one of said R,V,B signals, said coding pulse being received in at least one determined frame within at least one time window associated with a determined frame line,
counting time units onwards of the start of said frame line,
storing a first horizontal count value on receipt of a start edge of the coding pulse, and
storing a second horizontal count value on receipt of an end edge of the coding pulse,
wherein said first horizontal count value and said second horizontal count value determine the left limit and the right limit respectively, of said window in said video image.

46. The decoding method of claim 45 further comprising the steps of
receiving a code word in synchronism with the horizontal synchronization signal of the cathode ray tube in a second one of the R,G,B video signals, said code word being received a given number n1 of times in the determined frame in which the coding pulse is received, with a first function bit having a first determined value, where n1 is a non-zero integer number, within n1 first respective time windows, respectively associated with n1 determined lines of a first group of frame lines which are lines of the video image,
counting lines onwards of the start of the frame, and
storing a first vertical count value on receipt of a determined one of the n1 occurrences of said code word,
wherein said first vertical count value determines the upper limit of the window in the video image when said first function bit has said first determined value.

47. The decoding method of claim 46 wherein n1 is equal to 3, and wherein the first vertical count value is stored when the second occurrence of the code word is received.

48. The decoding method of claim 45 further comprising the steps of
receiving a code word in synchronism with the horizontal synchronization signal of the cathode ray tube in a second one of the R,G,B video signals, said code word being received a given number n2 of times in the determined frame in which the coding pulse is received, with the first function bit having a second determined value, where n2 is a non-zero integer number, within n2 second respective time windows, respectively associated with n2 determined lines of a second group of frame lines which are lines of the video image,
counting lines onwards of the start of the frame, and
storing a second vertical count value on receipt of a determined one of the n2 occurrences of the code word,
wherein said second vertical count value determines the lower limit of the window in the video image when the said first function bit has said second determined value.

49. The decoding method of claim 46 wherein n2 is equal to 3, and wherein the second vertical count value is stored when the first occurrence of the code word is received.

50. The decoding method of claim 46 further comprising the step of receiving clock pulses in synchronism with the horizontal scanning signal in a third one of the R,G,B video signals, in each of the time windows in which the code word is received, wherein said clock pulses are used for the decoding of the code word.

51. The decoding method of claim 45 further comprising the step of receiving a first code word in synchronism with the horizontal synchronization signal in a second one of the R,G,B video signals, this code word being received in the determined frame in which the coding pulse is received, within a time window associated with the first line of the video image, and the step of decoding a function word which is coded in said first code word.

52. The decoding method of claim 51, further comprising the step of receiving a second code word in synchronism with the horizontal synchronization signal in a third one of the R,G,B video signals, said second code word being received in a given number q1 of determined time, windows lying in the time window in which the first code word is received, and
further comprising the steps of decoding and storing a first value and a second value contained in said second code word,
wherein said first value and said second value determine the upper and the lower limit respectively of the window in the video image with reference to the first line of the video image.

53. The decoding method of claim 52 further comprising the step of receiving the coding pulse a given number q2 of times in q2 determined time windows, lying in the time window in which the first code word is received and distinct from the q1 time windows in which the second code word is received.

54. The decoding method of claim 51 further comprising the step of receiving clock pulses in synchronism with the horizontal synchronization signal in a third one of the R,G,B video signals, in each of the time windows in which the first code word is received, wherein said clock pulses are used for the decoding of said first code word.

55. The decoding method of claim 52 further comprising the step of receiving clock pulses in synchronism with the horizontal synchronization signal in a third one of the R,G,B video signals, in each of the time windows in which the second code word is received, wherein said clock pulses are used for the decoding of said second code word.

56. Device for decoding information for defining a determined window in a video image to be displayed in a monitor having a cathode ray tube, said information being coded in some at least of R,G,B video signals sent to the monitor, comprising:
means for receiving in a first one of said R,V,B signals a coding pulse synchronized with a horizontal synchronization signal of the cathode ray tube, said coding pulse being received in at least one determined frame within at least one time window associated with a determined frame line,
means for counting time units onwards of the start of said frame line,
means for storing a first horizontal count value on receipt of a start edge of the coding pulse, and
means for storing a second horizontal count value on receipt of an end edge of the coding pulse,
wherein said first horizontal count value and said second horizontal count value determine the left limit and the right limit respectively of said window in said video image.

57. The decoding device of claim 56 further comprising:
means for receiving in a second one of the R,G,B video signals, a code word in synchronism with the horizontal synchronization signal, a given number n1 of times in the frame in which the coding pulse is received, with a first function bit having a first determined value, where n1 is a non-zero integer number, within n1 first respective time windows, respectively associated with n1 determined lines of a first group of frame lines which are lines of the video image,
means for counting the lines onwards from the start of the frame and,
means for storing a first vertical count value on receipt of a determined one of the n1 occurrences of said code word,
wherein said vertical count value determines the upper limit of the window in the video image.

58. The decoding device of claim 57 wherein n1 is equal to 3, and wherein the first vertical count value is stored on receipt of the second occurrence of the code word.

59. The decoding device of claim 56 further comprising:
means for receiving in a second one of the R,G,B video signals, a code word in synchronism with the horizontal synchronization signal of the cathode ray tube, a given number n2 of times in the frame in which the coding pulse is received with a first function bit having a second determined value, where n2 is a non-zero integer number, within n2 first respective time windows, respectively associated with n2 determined lines of a second group of frame lines which are lines of the video image,
means for counting the lines onwards from the start of the frame, and
means for storing a second vertical count value on receipt of a determined one of the n2 occurrences of the code word,
wherein said second vertical count value determines the upper limit of the window in the video image.

60. The decoding device of claim 59, wherein n2 is equal to 3, and wherein the second vertical count value is stored when the first occurrence of the code word is received.

61. The decoding device of claim 56, further comprising:
means for receiving in a second of the R,G,B video signals a first code word in synchronism with the horizontal synchronization signal, said first code word being received in the frame in which the coding pulse is received within a time window associated with the first line of the video image, and
means for decoding a function word coded in the said first code word.

62. The decoding device of claim 61 further comprising means for receiving in a third one of the R,G,B video signals a second code word in synchronism with the horizontal synchronization signal, said second code word being received in a given number q1 of determined time windows lying in the time windows in which the first code word is received, and
means for decoding and storing a first value and a second value contained in said second code word,
wherein said first value and said second value determine the upper and the lower limit respectively of the window in the video image with reference to the first line of the video image.

63. The decoding device of claim 62 further comprising means for receiving the coding pulse a given number q2 of times in q2 determined time windows, lying in the time windows in which the first code word is received and distinct from said q1 time windows in which the second code word is received.

64. The decoding device of claim 61, further comprising means for receiving in a third one of the R,G,B signals clock pulses in synchronism with the horizontal synchronization signal, in each of the time windows in which the first code word is received, wherein said clock pulses are used for the decoding of the first code word.

65. The decoding device of claim 62, further comprising means for receiving in a third one of the R,G,B signals clock pulses in synchronism with the horizontal synchronization signal, in each of the time windows in which the second code word is received, wherein said clock pulses are used for the decoding of the second code word.

66. Video signal comprising R,G,B signals for coding a video image (13) to be displayed in a monitor having a cathode ray tube, and further comprising a horizontal synchronization signal of said cathode ray tube,
wherein a first one of said R,G,B video signals comprises a coding pulse in synchronism with said synchronization signal, for coding information for defining a determined window (14) in said video image;
wherein said coding pulse is present in at least one frame determined within at least one time window associated with a determined frame line, and
wherein said coding pulse has a temporal width which corresponds to the width of said window in said video image.

67. The video signal of claim 66, wherein a start edge of the coding pulse corresponds to the left limit of the window in the video image, and wherein an end edge of the coding pulse corresponds to the right limit of said window.

68. The video signal of claim 66, further comprising a code word in a second one of the R,G,B signals in synchronism with the horizontal synchronization signal, said code word being present in a given number m of determined frames, where m is a non-zero integer number, and being present a given number n1 of times in each of said m frames, where n1 is a non-zero integer number, within n1 first respective time windows, respectively associated with n1 lines of a first group of determined frame lines which are lines of the video image and which determine the upper limit of the window in the video image.

69. The video signal of claim 68, wherein the code word is further present a given number n2 of times in each of the m frames, where n2 is a non-zero integer number, within n2 second respective time windows, respectively associated with n2 lines of a second group of determined frame lines which are lines of the video image distinct from the n1 frame lines of the first group of frame lines in which the code word is present, and which determine the lower limit of the window in the video image.

70. The video signal of claim 68, wherein n1 is strictly greater than unity, and wherein the n1 lines of the first group of frame lines are consecutive lines of the frame.

71. The video signal of claim 69, wherein n2 is strictly greater than unity, and wherein the n2 lines of the second group are consecutive lines of the frame.

72. The video signal of claim 68, wherein the code word comprises identification bits which determine an identification code having for each occurrence of the code word a determined value known to a decoding device of the monitor.

73. The video signal of claim 68, wherein n1 is equal to 3, and wherein the identification code of the code words present in those of the first time windows which are associated respectively with the first one and with the third one of the lines of the first group of frame lines has a first determined value whereas the code word present in that of the first time windows which is associated with the second one of the lines of the first group has a second determined value which is the logical complement of said first determined value.

74 The video signal of claim 69, wherein n2 is equal to 3, and wherein the identification code of the code words present in those of the second time windows which are associated respectively with the first one and with the third one of the lines of the second group has a first determined value whereas the code word present in that of the second time windows which is associated with the second one of the lines of the second group has a second determined value which is the logical complement of the said first determined value.

75. The video signal of claim 69, wherein the code word further comprises at least one first function bit, and wherein said first function bit of the code words present in the n1 first time windows associated with the n1 lines of the first group have a first determined value, whereas the said first function bit of the code words present in the n2 second time windows associated with the n2 lines of the second group have a second determined value.

76. The video signal of claim 69, wherein the code word further comprises at least one second function bit having a first determined value so as to activate a command for modifying display parameters in the window with respect to the remainder of the video image, and having a second determined value for deactivating said command.

77. The video signal of claim 68, further comprising clock pulses in synchronism with the horizontal synchronization signal in a third one of the R,G,B video signals, in each of the time windows in which the code word is present.

78. The video signal of claim 68, wherein the coding pulse is present in each of the time windows in which the code word is present.

79. The video signal of claim 68, wherein m is equal to 2.

80. The video signal claim 66, further comprising a first code word in synchronism with the horizontal synchronization signal in a second of the R,G,B signals, wherein said first code word is present a given number p of times, in p determined frames, where p is an integer number, within p time windows respectively associated with the first line of the corresponding video image, and wherein said first code word comprises a given number N of bits defining an identification code and, further comprising a given number M of bits defining a function word, where N and M are integer numbers.

81. The video signal of claim 80, further comprising a second code word in synchronism with the horizontal synchronization signal in a third one of the R,G,B video signals, wherein said second code word is present in a given number q1 of determined time windows lying in said p time windows in which the first code word is transmitted, and wherein said second code word comprises a given number K of bits, where K is an integer number, which K bits encode a first value which determines the upper limit of the window in the video image with respect to the first line of the video image, as well as a second value which determines the lower limit of said window in the video image with respect to the first line of the video image.

82. The video signal of claim 81, wherein the coding pulse is present a given number q2 of times in q2 determined time windows, lying in the p time windows in which the first code word is present and distinct from the q1 time windows in which the second code word is present.

83. The video signal of claim 81, further comprising clock pulses in synchronism with the horizontal synchronization signal in a third one of the R,G,B video signals, in each of the time windows in which the first code word is transmitted.

84. The video signal of claim 82, further comprising clock pulses in synchronism with the horizontal synchronization signal in a third one of the R,G,B video signals, in each of the time windows in which the second code word is present.

85. The video signal of claim 80, wherein p is equal to 4.

86. The video signal of claim 81, wherein q1 is equal to 2.

87. The video signal of claim 82, wherein q2 is equal to 2.
